(19) United States
(12) Patent Application Publication
(10) Pub. No.: US 2014/0097363 A1
(43) Pub. Date: Apr. 10, 2014

(54) FLOATING SEAL RETAINER

(71) Applicant: ARRAY HOLDINGS, INC., Houston, TX (US)

(72) Inventor: Terry Glenn Young, Longview, TX (US)

(73) Assignee: Array Holdings, Inc., Houston, TX (US)

(21) Appl. No.: 13/645,582

(22) Filed: Oct. 5, 2012

(51) Int. Cl. F16K 31/163

(52) U.S. Cl. CPC F16K 31/163
USPC 251/58; 29/890.12

(57) ABSTRACT

Configurations of piston actuators having seal retainers doubly acting as pressure chambers are disclosed. Further disclosed are methods of installing pressure chambers in piston actuators.

### FIELD

The present invention relates to methods and devices pertaining to pressure seals on actuators. More specifically, the present invention relates to a simplified method of sealing a hydraulic actuator.

### BACKGROUND

Gate valves are generally comprised of a valve body having a central axis aligned with inlet and outlet passages, and a space between the inlet and outlet passages in which a slide, or gate, may be moved perpendicular to the central axis to open and close the valve. In the closed position, the gate surfaces typically seal against sealing rings which surround the fluid passage through the valve body. Gate valves have been used for centuries to control the flow of a great variety of fluids. Often the fluid to be controlled by the gate valve is under pressure. In the petroleum industry, gate valves are used along piping at various locations, and in particular are used in piping referred to in the petroleum industry as a Christmas tree, which is used as part of a drilling operation.

Actuators to open and close the gate valves may include manual operators, diaphragm-type operators, hydraulic operators or pneumatic operators. The actuator may include a bonnet assembly, which interconnects the valve body and the valve gate, and a bonnet stem which is movable with the gate via an operator. The operator typically has a maximum force capability for applying to the bonnet stem. It is sometimes desirable to provide additional opening/closing power on a temporary basis without having to remove the original operator. It is also desirable that the same operator be adaptable to various control accessories, such as a mechanical override, hydraulic override, heat sensitive lock open device, block open cap, electrical limit switch and/or other electrical accessories.

One problem associated with hydraulic or pneumatic actuators is how to maintain a pressurized state for actuation of a gate valve between an opened and closed position. Existing designs use a complex arrangement of multiple components such as retainers, seals and fasteners that result in longer times for assembly and repair of such actuators.

It would therefore be desirable to eliminate the use of multiple components an instead use a single component for sealing pressure. Such a device would result in easier field maintenance and downtime.

### SUMMARY

Particular embodiments of the invention disclosed herein pertain to an actuator for moving a valve gate between open and closed positions within a valve body. In such embodiments, the actuator may comprise an actuator housing defining an axis and having a proximal end oriented toward a gate valve and a distal end oriented away from the gate valve and attached to a top plug itself having a proximal side, the actuator housing further having an inner wall; an operator shaft with a distal end and a proximal end, the proximal end extending through a bore of a packing retainer fitted within an internal bore of a bonnet and into the valve body, the bonnet operatively connected to the proximal end of the actuator housing, the operator shaft defining a shaft axis; a seal retainer with external edges and an outer wall extending in a proximal direction to a proximal external edge, the seal retainer further having a distal end, and the seal retainer being adapted to receive a piston; a piston with a wall along the actuator housing axis, the piston having a proximal side and a distal side; a downstop having a proximal side and a distal side, the distal side in contact with the piston, and the proximal side in contact with a distal end of an operator shaft, the operator shaft having a proximal end attached to the valve gate; and wherein the seal retainer is pressurizeable and upon pressurization moves the piston in a proximal direction, thereby moving the operator shaft in a proximal direction and moving the valve gate in a proximal direction.

Further embodiments related to the actuator pertain to the inclusion of an actuator spring, the spring being capable of producing a biasing force opposing axial movement of the operator shaft toward the valve body.

It is contemplated that in the embodiments of the invention disclosed herein may pertain to a hydraulic actuator or a pneumatic actuator.

In further embodiments, at least one seal abuts at least one external edge of the seal retainer. In such embodiments, at least one seal may seal a space between the inner wall of the actuator housing and the outer wall of the seal retainer. Alternatively or additively, at least one seal may seal a space between the proximal end of the seal retainer wall and the piston wall.

Certain embodiments further comprise an actuator with a top shaft. In such embodiments a top shaft may be attached to the distal side of the piston and the seal retainer may have a retainer bore having a proximal end and a distal end, wherein the top plug also has a top plug bore adapted to receive the top shaft. In such embodiments, at least one seal may surround and abut the top shaft and seal a space between the top shaft and the distal end of the retainer bore.

In certain embodiments, the distal end of the seal retainer has a plurality of seals surrounding the top shaft. In such embodiments, the seals may be retained by substantially circular grooves surrounding the top shaft and either in the proximal side of the top plug or the distal side of the seal retainer.

It is further contemplated that the seal retainer may function as a pressure chamber and the seals may prevent loss of pressure. In such embodiments, the actuator housing further may further comprise a pressure inlet and the seal retainer further comprises a seal retainer bore aligned with the pressure inlet.

Other embodiments of the invention pertain to a method of installing a pressure chamber in a piston actuator, the method comprising: obtaining a cylindrical actuator housing defining a vertical axis and having a proximal end attached to a bonnet and a distal end, the actuator housing further having an inner wall of a defined diameter with a circular protrusion about midway between the proximal and distal ends, the protrusion extending from the inner wall in a perpendicular direction from the axis, wherein the inner diameter of the actuator housing at the protrusion has a defined protrusion diameter; installing a piston with a proximal side and a distal side and an outer wall less than or equal to the defined protrusion diameter, wherein the protrusion has a distal side, and the distal end of the piston is always distal or equal to the distal side of the protrusion; inserting a first substantially circular seal having a proximal side and a distal side into the distal end of the actuator housing, wherein the proximal side of the seal is positioned on the distal side of the protrusion, placing a seal retainer a distal side and having a cylindrical wall having a space adapted to receive the piston into the distal end of the actuator housing, the cylindrical wall having a proximal end abutting the distal side of the first substantially circular seal; placing a second substantially circular seal having a proximal side and a distal side into the distal end of the actuator housing, and attaching a top plug having a proximal side to the distal end of the actuator housing, wherein the second substantially circular seal is retained between proximal side of the top plug and the distal side of the seal retainer; and wherein the actuator housing has a pressure inlet and the seal retainer has a seal retainer bore such that the pressure inlet and the seal retainer bore are aligned and connected to a pressure source, and the seal retainer space adapted to receive the piston functions as a pressure chamber.

In such embodiments of this method, the seals may prevent fluid from escaping the pressure chamber and into the actuator.

In further embodiments of the method, the distal side of the piston may be attached to a top shaft, the seal retainer may have a bore adapted to receive the top shaft and the top plug may have a bore adapted to receive the top shaft. In such embodiments, the method may further comprising a installing a third substantially circular seal, the seal surrounding and abutting the top shaft and sealing a space between the top shaft and the retainer bore adapted to receive the top shaft, the seal being located between the proximal side of the top plug and the distal side of the seal retainer.

It is further contemplated that in the embodiments of the invention disclosed herein, the actuator may be a hydraulic actuator or a pneumatic actuator with a piston.

### BRIEF DESCRIPTION OF THE DRAWINGS

FIG. 1 is a cross sectional drawing of a hydraulic actuator illustrating the sealing system.

FIG. 2 is a cross sectional drawing of the hydraulic actuator illustrating the sealing system wherein the actuator is pressurized.

### LIST OF REFERENCE NUMERALS

10 hydraulic actuator

20 top plug

30 actuator housing

40 threaded attachment

50 top plug seal

60 retainer ring

70 inner polypak groove

80 outer polypak groove

90 inner polypak seal

100 outer polypak seal

110 seal retainer

120 pressure chamber

130 seal retainer wall

140 proximal polypak seal

150 actuator housing protrusion

160 ware bearing indentation

170 ware bearing

180 combination top shaft and piston

185 seal retainer distal bore

190 pressure inlet

200 pressure outlet

210 seal retainer bores

220 downstop

230 operator shaft

240 actuator spring

250 downstop bore

260 bonnet ring

270 packing retainer

280 bonnet bore

290 bonnet

300 packing retainer bonnet bore threaded interface

310 packing retainer bore

320 valve body

380 bonnet ring threaded junction

390 bolts

400 valve gate

410 valve throughbore

### DETAILED DESCRIPTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “conduit” means and refers to a fluid flow path.

As used herein, the term “line” means and refers to a fluid flow path.

As used herein, the term “fluid” refers to a non-solid material such as a gas, a liquid or a colloidal suspension capable of being transported through a pipe, line or conduit. Examples of fluids include by way of non-limiting examples the following: natural gas, propane, butane, gasoline, crude oil, mud, water, nitrogen, sulfuric acid and the like.

As used herein, the term “attached,” or any conjugation thereof describes and refers to the at least partial connection of two items.

As used herein, the term “polypak,” or any conjugation thereof may refer to multi-purpose seals that are molded, multi-purpose sealing devices combining an O-Ring type O-spring with a conventional lip seal.

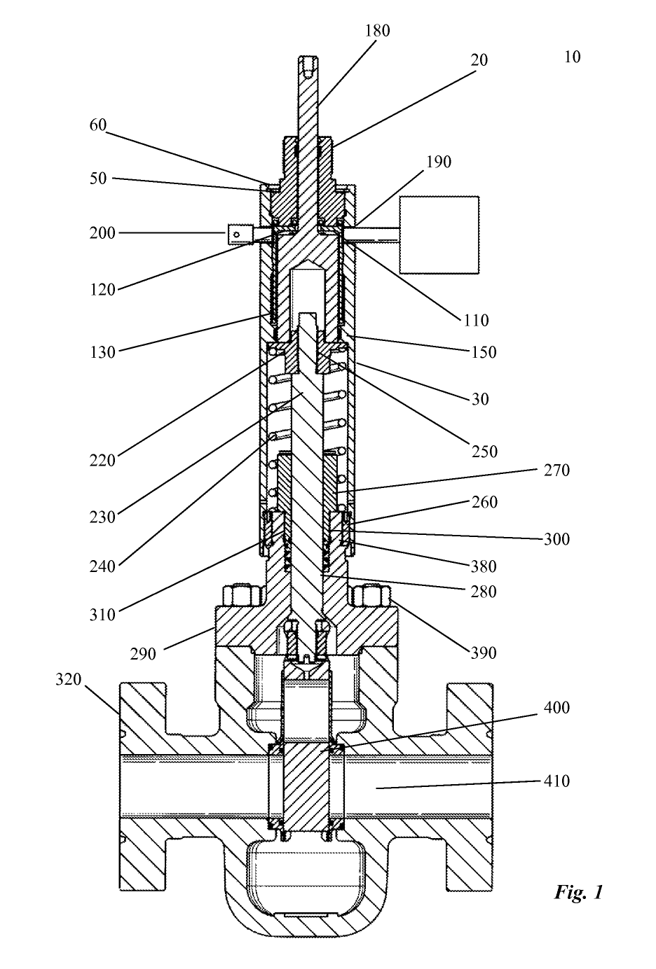

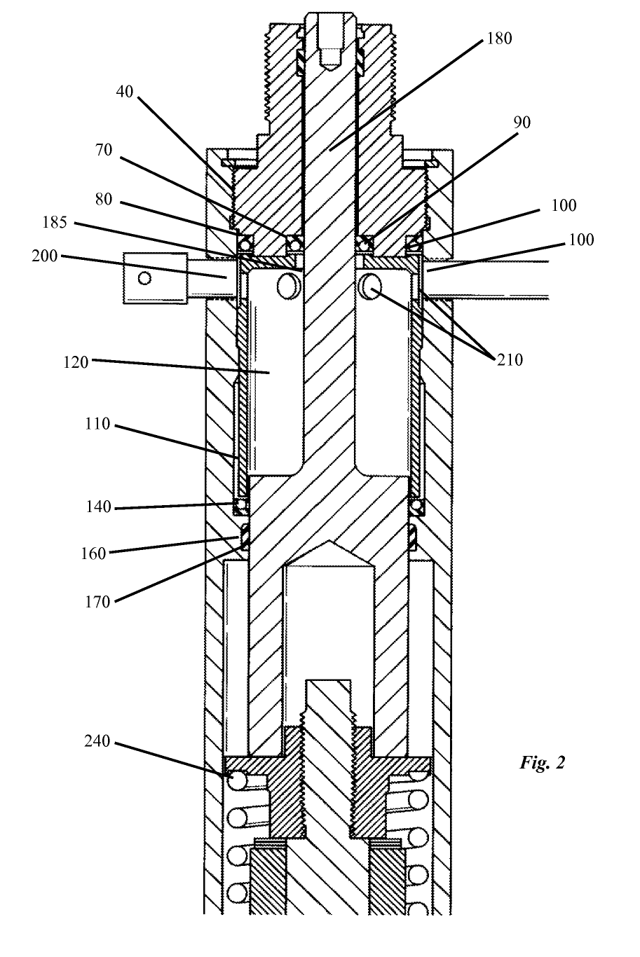

Now, referring to FIG. 1, is a cross sectional drawing of a hydraulic actuator 10 illustrating the sealing system. As can be seen in FIG. 1, the hydraulic actuator 10 has a top plug 20 attached to the actuator housing 30. In this embodiment, the attachment is a threaded attachment 40, which may be viewed in FIG. 2. In other embodiments, it is contemplated that the attachment may be different, such as the use of bolts, screws, and the like. Immediately distal to the threaded attachment 40 is top plug seal 50 as and a retainer ring 60 both of which are illustrated in FIG. 1. The retainer ring 60 may be threaded such that there is an attachment between the outside of the retainer ring 60 and the inside of the actuator housing 30.

As seen in FIG. 2, the proximal end of the top plug 20 has a substantially circular inner polypak groove 70 and a substantially circular outer polypak groove 80. Within the inner polypak groove 70 is an inner polypak seal 90. Likewise, within the outer polypak groove 80 is an outer polypak seal 100. Immediately distal to the top plug 20, the polypak grooves and the polypak seals, is a seal retainer 110, which may be viewed in FIG. 1 or FIG. 2. The distal side of the seal retainer 110 engages the two aforementioned polypak seals to inhibit pressure exit from the pressure chamber, which is immediately proximal to the proximal side of the polypak seal. In addition, the seal retainer 110 has a seal retainer wall 130, which comprises the seal retainer 110 in its entirety. The seal retainer wall 130 typically shaped in a cylindrical fashion, extending proximally from the proximal side of the seal retainer 110. The seal retainer wall 130 has a proximal end which contacts a third or proximal polypak seal 140 which may be viewed in FIG. 2. In certain embodiments, immediately proximal to the proximal polypak seal 140, such as the embodiment of FIG. 1, is an actuator housing protrusion 150 on which the proximal polypak seal 140 rests.

In practice, the actuator housing is made of a durable metal, such as aluminum, stainless steel, titanium and the like. Likewise, the top plug may be made of a durable metal such as aluminum, stainless steel, titanium and the like. A typical actuator housing can be between about 10 inches to about 30 inches in diameter. The shape is generally spherical. In the case of using steel in the construction of the actuator housing, the thickness is typically from about ¼ inch to about ½ inch.

Further, the polypak seals can be made of materials such as delrin, nylon, thermoplastics, resins, polyurethanes, phenolics, acetals, polyacrylates, epoxides, polycarbonates, polyester, aramids and the like.

Still further, pertaining to the actuator housing protrusion 150, the actuator housing protrusion 150 may possess a ware bearing indentation 160 such that a ware bearing 170 may surround the piston proximal to the seal retainer 110 as illustrated in FIG. 2.

Within the seal retainer 110, and surrounded by the seal retainer wall 130 is a pressure chamber 120 which may be viewed in FIG. 1 or FIG. 2, which is capable of being pressurized by a gas or a liquid to move the combination top shaft and piston 180 in a distal direction.

In other embodiments, it is conceivable that the top shaft and piston may be separate elements. In such embodiments, the top shaft typically would have a top shaft flange at its most proximal end and the piston would typically have an indentation capable of receiving the top shaft flange on its distal side. Typically in such cases, a retainer ring 60 secures the top shaft flange to the piston.

Regarding a top shaft or a combination top shaft and piston 180, the seal retainer 110 possesses a seal retainer distal bore 185 adapted to receive the top shaft as illustrated in FIG. 2. The seal retainer 110, having a seal retainer wall 130, is adapted to receive the piston. When the seal retainer 110 has received the piston, the inside of the seal retainer functions as a pressure chamber 120.

In most embodiments, the diameter of the top shaft portion of the combination top shaft and piston 180, or a top shaft alone can be varied depending on loading and stress conditions on the top shaft portion of the combination top shaft and piston 180, or a top shaft. Typically, such a diameter of the top shaft will be between one and three inches with a top shaft length between 6 and 30 inches. As the top shaft protrudes from the top plug 20, the position of the top shaft can serve as an indicator to whether a valve gate is in the open or closed position. In general, the top shaft and piston will be made of a durable metal such as steel.

The pressure chamber 120 is in fluid communication with a pressure inlet 190 and a pressure outlet 200 situated perpendicular to the distal to proximal axis of the top shaft and piston. More specifically, the pressure inlet 190 and pressure outlet 200 are bores within the side of the actuator housing 30. Still further, the seal retainer wall 130 has seal retainer bores 210 as illustrated in FIG. 2, which align with the pressure inlet 190 and the pressure outlet 200, such that pressure in the form of a liquid or a gas may enter or exit the pressure chamber 120.

Referring again to FIG. 1, the proximal end of the piston abuts the distal side of a downstop 220. The downstop 220 serves to retain the operator shaft 230 and its proximal side is the distal pressure point for the actuator spring 240. Regarding the ability of the downstop 220 to retain the operator shaft 230, the center of the downstop 220 has a downstop bore 250 adapted to receive a distal portion of the operator shaft 230. This distal portion of the operator shaft 230 is affixed to the downstop bore 250. As seen in FIG. 1, the downstop bore 250 is threaded and adapted to receive a reciprocally threaded distal portion of the operator shaft 230. In alternative embodiments, the distal portion of the operator shaft 230 may be affixed to the downstop bore 250 by pinning or bolting the distal portion of the operator shaft 230 to the downstop bore 250. While it is contemplated that the downstop 220 and the operator shaft 230 may be made of any rigid material, these components are preferably formed from stainless steel.

As indicated previously the actuator spring 240 has a distal end and a proximal end. The distal end of the actuator spring 240 contacts the proximal end of the downstop 220. Likewise, the proximal end of the actuator spring 240 is in contact with the bonnet ring 260. Further, the actuator spring 240 has an internal area such that the actuator spring surrounds 240 the operator shaft 230 and, near the distal end of the actuator, surrounds the packing retainer 270.

The packing retainer 270 of the present invention as illustrated in FIG. 1, is situated within the actuator housing 30 near its proximal end. Further the packing retainer 270, which in many embodiments has a cylindrical shape, fits within the centrally positioned bonnet bore 280 of the bonnet 290. The bonnet bore 280 is along a distal to proximal axis defined by the operator shaft 230. The packing retainer, in most embodiments, is affixed to the bonnet bore 280 through a packing retainer bonnet bore threaded interface 300. More specifically, the bonnet bore 280 is threaded and adapted to receive the packing retainer 270 which possesses reciprocal threading near its proximal end.

Still further, the packing retainer 270 has a centrally located packing retainer bore 310. The packing retainer bore is along the distal to proximal axis defined by the operator shaft 230. Further, the packing retainer bore 310 is adapted to receive the operator shaft 230, which travels through the packing retainer 270 and into the valve body 320.

To seal the packing retainer 270 against the bonnet 290 and to prevent pressure from leaking from the packing retainer bore 310, the packing retainer 270 possesses numerous sealing components.

To secure the actuator housing 30 to the bonnet 290 is a bonnet ring 260. The bonnet 290, near its distal end has a bonnet ring threaded junction 380 ultimately connecting the bonnet 290 to the actuator housing 30 via the bonnet ring 260. Likewise, the bonnet ring 260 has internal threading adapted to receive the external threading of the bonnet 290. In addition, the proximal end of the actuator housing 30 may have internal threading adapted to receive external threading along the bonnet ring 260. However, it is contemplated that in certain embodiments, the actuator housing 30 may be affixed to the bonnet ring 260 by a different mechanism such as bolting, pinning and the like. Likewise, the bonnet 290 may be attached to the bonnet ring 260 by bolting, pinning and the like.

The bonnet 290 as depicted in FIG. 1 is attached to the valve body. The actuator is bolted to the valve body 320 via a series of bolts 390. As can be seen, the operator shaft 230 is attached at its proximal end, to a valve gate 400 which sits within the valve body 320 and allows or prevents fluid from passing through the valve throughbore 410.

Referring to FIG. 2, the actuator of the present invention is shown in a pressurized configuration. As can be seen, the combination top shaft and piston 180 have moved in a proximal direction relative to its position as depicted in FIG. 1. Further, the actuator spring 240 in FIG. 2 is in a compressed configuration relative to the uncompressed configuration as depicted in FIG. 1.

Still referring to FIG. 2, the pressure chamber 120 is shown full of fluid or gas, such that the combination top shaft and piston 180 is pushed in a proximal direction. As can be seen, seal retainer 110 has seal retainer bores 210 which align with the pressure inlet 190 and the pressure outlet 200, such that pressure in the form of a liquid or a gas may enter or exit the pressure chamber 120.

FIG. 2 further depicts the proximal polypak seal 140 in relation to the piston, the proximal polypak seal 140 is illustrative of pressure retention such that a hydraulic fluid or gas only enters and exits through the seal retainer bores 210 and the pressure inlet 190 and pressure outlet 200, respectively.

In implementation, fluid flows into the pressure chamber 120 through the pressure inlet 190 and a seal retainer bore 210. In general, the fluid is pushed into the pressure chamber from an external pressure source which is attached to the pressure inlet via a pressure line. Such pressure sources may include hydraulic pumps or pressurized gas cylinders, depending on the application. The fluid will be prevented from exiting the pressure chamber 120 and the pressure outlet 200 by a plug in the pressure outlet 200 or a pressure relief valve in the pressure outlet 200. Consequently, the pressure chamber 200, which is the chamber formed between the seal retainer and the combination top shaft and piston 180, will increase in volume. Thus, forcing the combination top shaft and piston 180 in a proximal direction. By forcing the piston in a proximal direction, the actuator spring 240 will become compressed by proximal movement of the downstop 220. Further, the downstop 220 will force the operator shaft 230 to move in a proximal direction. As the operator shaft is affixed to a valve gate 400 within the valve body 320, the valve gate 400 will also move in a proximal direction. Movement of the valve gate 400 in a proximal direction will either allow fluid to flow through the valve throughbore, or prevent fluid from flowing through the valve throughbore.

Regarding the pressurization, keeping the fluid from escaping the pressure chamber 200 is accomplished by a series of polypak seals. To keep fluid from exiting the pressure chamber where the top shaft is centered with respect to the seal retainer 110 is an inner polypak seal 90 which is situated within an inner polypak groove 70 at the proximal end of the top plug 20. To keep the fluid from exiting the pressure chamber 200 from the space between the seal retainer bore 210 and the pressure inlet 190 in a distal direction, an outer polypak seal 100 is employed. The outer polypak seal 100 is positioned within the outer polypak groove 80 at the proximal end of the top plug 20. To keep the fluid from exiting the pressure chamber 200 from the space between the proximal end of the seal retainer 110 and the actuator housing 30, is a proximal polypak seal 140, which is positioned between the proximal end of the seal retainer wall 130 and the distal side of the actuator housing protrusion 150. This same polypak seal also prevents escape of fluid from the space between the piston component of the combination top shaft and piston 180 and the inside of the seal retainer wall 130.

Further, in implementation, to move the piston from a proximal position to a distal position, the fluid filling the pressure chamber 200 is released. The pressure may be released by removing a plug in the pressure outlet, or by turning off, or otherwise reversing the pressure supplied by the external pressure source.

The foregoing detailed disclosure and description of the invention is illustrative and explanatory thereof, and it will be appreciated by those skilled in the art, that various changes in the size, shape and materials as well as in the details of the illustrated construction, reliability configurations, or combination of features of the various valve actuator elements of the present invention may be made without departing from the spirit of the invention.

1. An actuator for moving a valve gate between open and closed positions within a valve body, the actuator comprising:
a. an actuator housing defining an axis and having a proximal end oriented toward a gate valve and a distal end oriented away from the gate valve and attached to a top plug itself having a proximal side, the actuator housing further having an inner wall;
b. an operator shaft with a distal end and a proximal end, the proximal end extending through a bore of a packing retainer fitted within an internal bore of a bonnet and into the valve body, the bonnet operatively connected to the proximal end of the actuator housing, the operator shaft defining a shaft axis;
c. a seal retainer with external edges and an outer wall extending in a proximal direction to a proximal external edge, the seal retainer further having a distal end, and the seal retainer being adapted to receive a piston;
d. a piston with a wall along the actuator housing axis, the piston having a proximal side and a distal side;
e. a downstop having a proximal side and a distal side, the distal side in contact with the piston, and the proximal side in contact with a distal end of an operator shaft, the operator shaft having a proximal end attached to the valve gate; and
wherein the seal retainer is pressurizeable and upon pressurization moves the piston in a proximal direction, thereby moving the operator shaft in a proximal direction and moving the valve gate in a proximal direction.

2. The actuator of claim 1, further comprising an actuator spring, the spring being capable of producing a biasing force opposing axial movement of the operator shaft toward the valve body.

3. The actuator of claim 1, wherein the actuator is a hydraulic actuator.

4. The actuator of claim 1, wherein the actuator is a pneumatic actuator.

5. The actuator of claim 1, wherein at least one seal abuts at least one external edge of the seal retainer.

6. The actuator of claim 5, wherein at least one seal seals a space between the inner wall of the actuator housing and the outer wall of the seal retainer.

7. The actuator of claim 5, wherein at least one seal seals a space between the proximal end of the seal retainer wall and the piston wall.

8. The actuator of claim 1, wherein a top shaft is attached to the distal side of the piston and the seal retainer has a retainer bore having a proximal end and a distal end, and wherein the top plug has a top plug bore adapted to receive the top shaft.

9. The actuator of claim 1, wherein at least one seal surrounds and abuts the top shaft and seals a space between the top shaft and the distal end of the retainer bore.

10. The actuator of claim 9, wherein the distal end of the seal retainer has a plurality of seals surrounding the top shaft.

11. The actuator of claim 10, wherein the seals are retained by substantially circular grooves surrounding the top shaft and either in the proximal side of the top plug or the distal side of the seal retainer.

12. The actuator of claim 5, wherein the seal retainer functions as a pressure chamber.

13. The actuator of claim 12, wherein the seals prevent loss of pressure from the pressure chamber.

14. The actuator of claim 13, wherein the actuator housing further comprises a pressure inlet and the seal retainer further comprises a seal retainer bore aligned with the pressure inlet.

15. A method of installing a pressure chamber in a piston actuator, the method comprising:
a. obtaining a cylindrical actuator housing defining a vertical axis and having a proximal end attached to a bonnet and a distal end, the actuator housing further having an inner wall of a defined diameter with a circular protrusion about midway between the proximal and distal ends, the protrusion extending from the inner wall in a perpendicular direction from the axis, wherein the inner diameter of the actuator housing at the protrusion has a defined protrusion diameter;
b. installing a piston with a proximal side and a distal side and an outer wall less than or equal to the defined protrusion diameter, wherein the protrusion has a distal side, and the distal end of the piston is always distal or equal to the distal side of the protrusion;
c. inserting a first substantially circular seal having a proximal side and a distal side into the distal end of the actuator housing, wherein the proximal side of the seal is positioned on the distal side of the protrusion,
d. placing a seal retainer a distal side and having a cylindrical wall having a space adapted to receive the piston into the distal end of the actuator housing, the cylindrical wall having a proximal end abutting the distal side of the first substantially circular seal;
e. placing a second substantially circular seal having a proximal side and a distal side into the distal end of the actuator housing, and attaching a top plug having a proximal side to the distal end of the actuator housing, wherein the second substantially circular seal is retained between proximal side of the top plug and the distal side of the seal retainer; and
wherein the actuator housing has a pressure inlet and the seal retainer has a seal retainer bore such that the pressure inlet and the seal retainer bore are aligned and connected to a pressure source, and the seal retainer space adapted to receive the piston functions as a pressure chamber.

16. The method of claim 15, wherein the seals prevent fluid from escaping the pressure chamber and into the actuator.

17. The method of claim 16, wherein the distal side of the piston is attached to a top shaft, the seal retainer has a bore adapted to receive the top shaft and the top plug has a bore adapted to receive the top shaft.

18. The method of claim 17, further comprising a installing a third substantially circular seal, the seal surrounding and abutting the top shaft and sealing a space between the top shaft and the retainer bore adapted to receive the top shaft, the seal being located between the proximal side of the top plug and the distal side of the seal retainer.

19. The method of claim 15, wherein the method is applied to a hydraulic actuator.

20. The method of claim 15, wherein the method is applied to a pneumatic actuator.
